(19) United States
(12) Patent Application Publication
(10) Pub. No.: US 2026/0370873 A1
(43) Pub. Date: Nov. 19, 2026

(54) SIMPLIFIED LEARNING-BASED DYNAMIC POINT CLOUD COMPRESSION

(71) Applicant: InterDigital VC Holdings, Inc., Wilmington, DE (US)

(72) Inventors: Muhammad Asad LODHI, Highland Park, NJ (US); Junghyun AHN, New York, NY (US); Dong TIAN, Boxborough, MA (US)

(21) Appl. No.: 19/210,607

(22) Filed: May 16, 2025

(51) Int. Cl. H04N 19/597; H04N 19/107; H04N 19/172

(52) U.S. Cl. CPC H04N 19/597; H04N 19/107; H04N 19/172

(57) ABSTRACT

In one implementation, a method of decoding point cloud data is provided, comprising: determining a feature type to be INTRA or INTER; decoding one of an INTRA feature and an INTER feature based on the feature type; and decoding a point cloud frame based on one of the INTRA feature and the INTER feature. On the encoder side, a method of encoding point cloud data is provided, comprising: determining a feature type to be INTRA or INTER; obtaining one of an INTRA feature and an INTER feature to be encoded based on the feature type; and encoding one of the INTRA feature and the INTER feature based on the feature type.

### BACKGROUND

The present application is related to point cloud compression and processing.

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### BRIEF SUMMARY

Briefly stated, in one embodiment, a method of decoding point cloud data is presented, comprising: determining a feature type to be INTRA or INTER; decoding one of an INTRA feature and an INTER feature based on the feature type; and decoding a point cloud frame based on one of the INTRA feature and the INTER feature.

According to another embodiment, a method of encoding point cloud data is presented, comprising: determining a feature type to be INTRA or INTER; obtaining one of an INTRA feature and an INTER feature to be encoded based on the feature type; and encoding one of the INTRA feature and the INTER feature based on the feature type.

According to another embodiment, an apparatus for decoding point cloud data is presented, comprising one or more processors and at least one memory coupled to the one or more processors, wherein the one or more processors are configured to: determine a feature type to be INTRA or INTER; decode one of an INTRA feature and an INTER feature based on the feature type; and decode a point cloud frame based on one of the INTRA feature and the INTER feature.

According to another embodiment, an apparatus for encoding point cloud data is presented, comprising one or more processors and at least one memory coupled to the one or more processors, wherein the one or more processors are configured to: determine a feature type to be INTRA or INTER; obtain one of an INTRA feature and an INTER feature to be encoded based on the feature type; and encode one of the INTRA feature and the INTER feature based on the feature type.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 illustrates a block diagram of a system within which aspects of the present embodiments may be implemented;

FIG. 2A and FIG. 2B illustrate a prior design for Feature-based Coding, where both INTRA and INTER features are used, FIGS. 2C-2J illustrate the individual modules in feature-based coding, and FIG. 2K and FIG. 2L illustrate the octree encoder and decoder, respectively;

FIG. 3A and FIG. 3B illustrate a proposed design for Feature-based Coding, where either INTRA or INTER feature is selected, according to an embodiment;

FIG. 4A and FIG. 4B illustrate a proposed design for level-by-level Feature-based Coding, according to an embodiment;

FIG. 5A and FIG. 5B illustrate a proposed design for level-by-level Octree-based Coding, according to an embodiment;

FIG. 6A and FIG. 6B illustrate a proposed design for level-by-level Feature-based Coding with dependency on ancestral levels, FIG. 6C and FIG. 6D illustrate Motion Encoder and Motion Decoder with a Hierarchical Hyperprior design, and FIG. 6E illustrates the Reconstruction from Feature module, according to an embodiment;

FIG. 7 illustrates a method of encoding a point cloud, according to an embodiment; and

FIG. 8 illustrates a method of decoding a point cloud, according to an embodiment.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

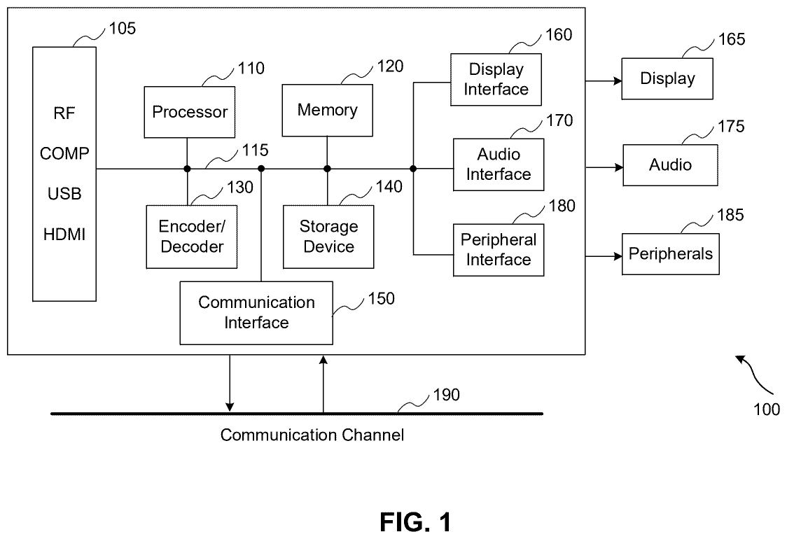

Referring to the drawings, there is shown in FIG. 1 a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

### Point Cloud Data Format

Point cloud data is also believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

### Point Cloud Data Use Cases

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds have become a hot topic and foreseen by many as the future of 2D flat video. The basic idea is to immerse the viewer in an environment all around the viewer as opposed to standard TV where the viewer can only look at the virtual world in front of the viewer. There are several gradations in the immersivity depending on the freedom of the viewer in the environment. Point cloud is a good format candidate to distribute VR worlds. They may be static or dynamic and are typically of average size, say no more than millions of points at a time.

Point clouds may also be used for various purposes such as culture heritage/buildings in which objects like statues or buildings are scanned in 3D to share the spatial configuration of the object without sending or visiting it. Also, it is a way to ensure preserving the knowledge of the object in case it may be destroyed, for instance, a temple by an earthquake. Such point clouds are typically static, colored, and huge.

Another use case is in topography and cartography in which using 3D representations, maps are not limited to the plane and may include the relief. Google Maps is now a good example of 3D maps but uses meshes instead of point clouds. Nevertheless, point clouds may be a suitable data format for 3D maps and such point clouds are typically static, colored, and huge.

World modeling and sensing via point clouds could be an essential technology to allow machines to gain knowledge about the 3D world around them, which is crucial for the applications discussed above.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

The first step for any processing or inference on the point cloud is to have efficient storage methodologies. To store and process the input point cloud with affordable computational cost, one solution is to down-sample it first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down sampled) into a bitstream through entropy coding techniques for lossless compression.

In addition to lossless coding, many scenarios seek lossy coding for significantly improved compression ratio while maintaining the induced distortion under certain quality levels. To achieve a less lossy coding, an efficient point feature extractor is necessary to improve the accuracy of the reconstruction within the given resource budget.

### Learning-Based Point Cloud Compression

Since point cloud data is composed of two components: geometry information and attribute information, the compression of point clouds can be classified into two categories: geometry coding and attribute coding.

Examples of existing learning-based point cloud geometry compression techniques are deep octree coding, end-to-end feature-based geometry coding. With deep octree coding, neural network-based models are utilized to estimate the occupancy probabilities. Such estimated probabilities are then used to help the arithmetic coder to encode or decode a binary flag indicating whether a child octree voxel is occupied or empty. This work concerns the problem of dynamic point cloud compression which benefits both feature-based geometry coding as well as octree coding.

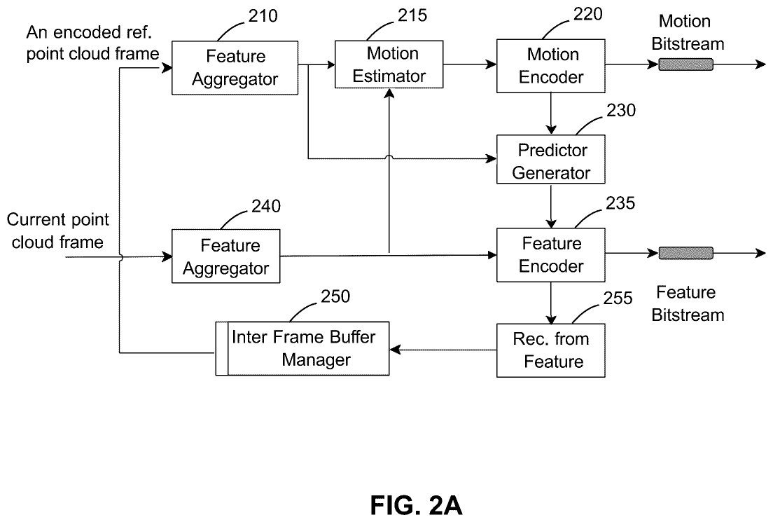

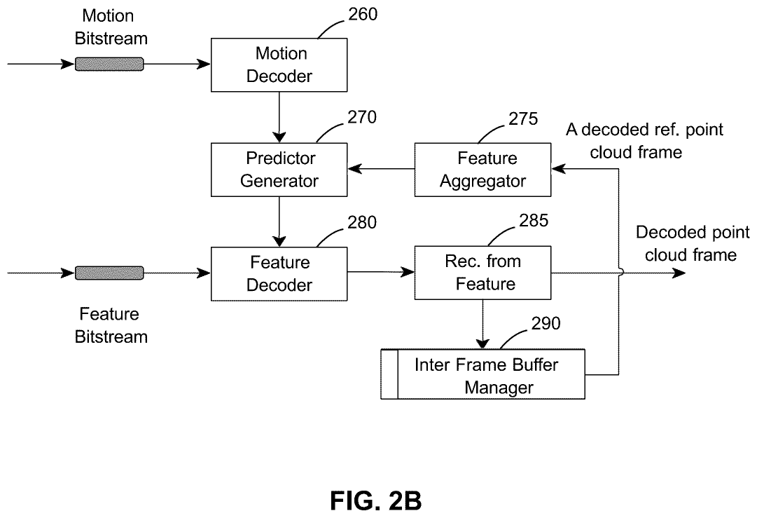

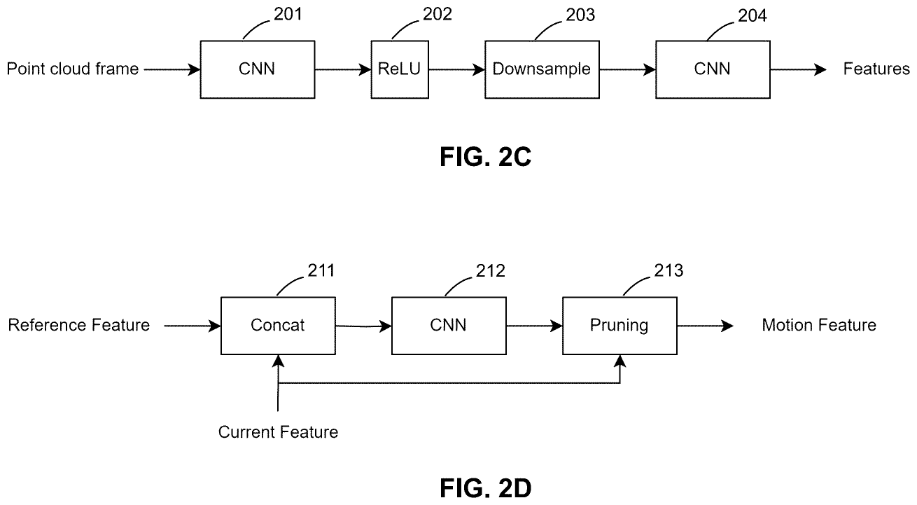

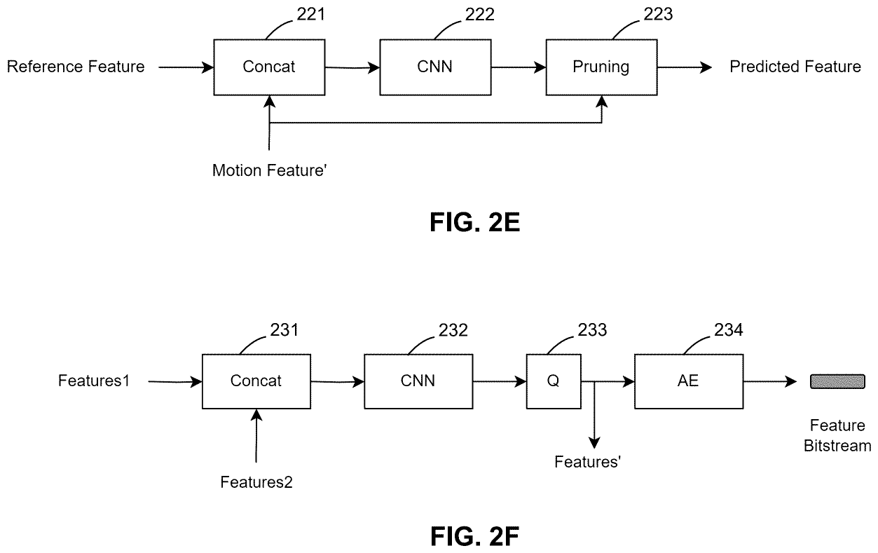

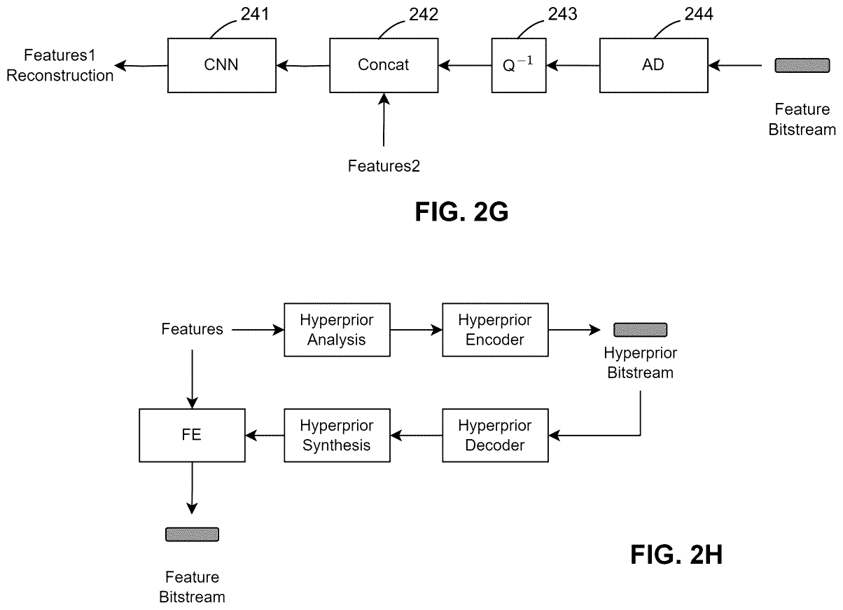

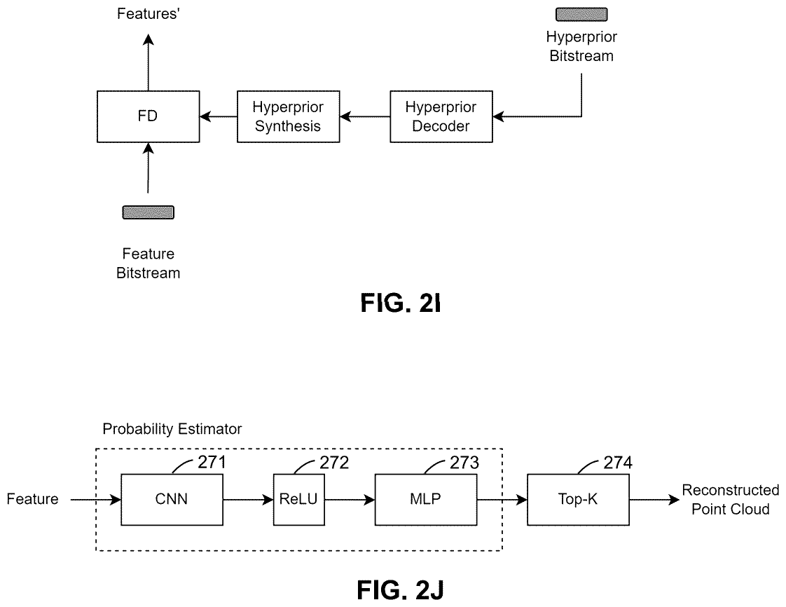

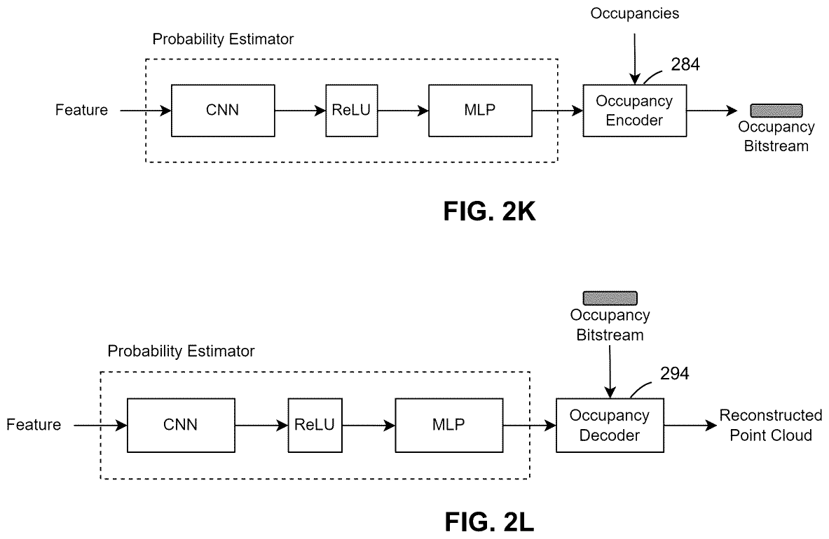

We first depict an earlier proposed method in FIG. 2A and FIG. 2B for Feature-based Coding from a commonly owned U.S. patent applicant Ser. No. 18/784,466, entitled “An end-to-end learning-based dynamic point cloud coding framework” (our docket number 2024PF00494), the teachings of which are incorporated herein by reference. The earlier method proposed a unified architecture between Octree-based and Feature-based coding, but here we only illustrate Feature-based Coding to keep the discussion short.

On the encoder side as illustrated in FIG. 2A, a Feature Aggregator module (240) takes a current point cloud frame and extracts an intra feature. In parallel, another Feature Aggregator module (210, with shared parameters as the first one) takes an encoded reference point cloud frame to extract a reference feature. This reference feature and the intra feature are then digested by a Motion Estimator module (215) to produce a motion feature which is encoded via the Motion Encoder module (220) into a bitstream. The encoded motion feature along with the reference feature are used by the Predictor Generator module (230) to produce an inter predicted feature. The Feature Encoder (235), which is a conditional coder, then encodes the intra feature into a bitstream with the inter predicted feature as the condition. The encoded intra feature is also used by the Reconstruction from Feature module (255) to produce a reconstructed current frame which goes into the Inter Frame Buffer Manager (250) to act as a reference point cloud frame for the next frame to be encoded.

The decoder side, as illustrated in FIG. 2B, proceeds by first decoding the motion feature from the bitstream via Motion Decoder (260), followed by aggregation of the motion feature with the reference feature obtained through Feature Aggregator (275) to again obtain the inter predicted feature via the Predictor Generator (270). The Feature Decoder (280), which is also a conditional coder, produces a reconstructed feature using the decoded intra feature from the bitstream and the inter predicted feature. The final reconstruction is obtained from the Reconstruction from Feature module (285) through the reconstructed feature. The reconstructed current frame goes into the Inter Frame Buffer Manager (290) to act as a reference point cloud frame for the next frame to be decoded.

We also provide some details of the modules from the earlier proposed method here. The Feature Aggregator module (210, 240), as illustrated in FIG. 2C, consists of some sparse convolutional network (CNN, 201) operating on an input point cloud frame, followed by rectified liner unit (ReLU, 202) non-linearity, further followed by downsampling (203) of the intermediate feature also implemented via CNN, and a final CNN (204) to produce the output feature.

The Motion Estimator (215) and Predictor Generator (230, 270) modules, as illustrated in FIG. 2D and FIG. 2E, respectively, have a similar architecture consisting of concatenation (211, 221) of two input features, followed by a CNN (212, 222) and finally pruning (213, 223) via one of the input features to produce the output feature. The difference between the two modules lies only in the input and output features.

Next, the Feature Encoder (235) and Feature Decoder (280) modules, are illustrated in FIG. 2F and FIG. 2G, respectively. The Feature Encoder first concatenates (231) the two input features, followed by a CNN (232) and quantization (233) to produce a quantized feature which is written into a bitstream via an arithmetic encoder (234). The Feature Decoder has a mirror structure of the Feature Encoder. The Feature Decoder starts by first decoding (244) a quantized feature from the bitstream followed by an inverse quantization (243) to produce an intermediate feature. The intermediate feature is further concatenated (242) with a second feature (that is the same feature as on the encoder side) followed by a CNN (241) to produce the output feature.

A more advanced design for the Feature Encoder and Feature Decoder modules following the well-known hyperprior model is illustrated in FIG. 2H and FIG. 2I, respectively.

The Reconstruction from Feature module (255, 285), as illustrated in FIG. 2J, consists of a Probability Estimator module followed by a non-learning based Top-K module (274). The Probability Estimator module is composed of a CNN (271) followed by ReLU (272) and finally a multilayer perceptron (MLP) layer (273) to predict the occupancy probabilities. The Top-K module (274) then sorts the probabilities and classifies the voxels corresponding to the K highest probabilities as being occupied.

A similar design is used for Octree-based coding, where the Reconstruction from Feature module is replaced by Octree Encoder and Octree Decoder, in the encoder and decoder, respectively. The design of the Octree Encoder and Octree Decoder are illustrated in FIG. 2K and FIG. 2L, respectively. Similar to the Reconstruction from Feature module, first some occupancies probabilities are produced from an input feature. However, instead of classification based on the probabilities via Top-K, the Octree Encoder uses an arithmetic encoder (284) to losslessly encode the occupancies while the Octree Decoder uses an arithmetic decoder (294) to losslessly decode those occupancies.

We now describe our proposed architecture for achieving lower computational and parameter complexity for end-to-end dynamic point cloud compression. It should be noted that details of the implementation of individual modules in the proposed work remain similar to the earlier proposed architectures from 2024PF00494. However, the inputs and the order of execution of these modules are modified here.

### Simplified Conditional Coding

The motivation of our proposed simplified design is that we want to choose and code only the best feature (under a given scenario) instead of aggregating and encoding information from multiple features, in which case the features with poor quality can negatively impact the overall feature. To this end, we focus on the features that are input to the conditional coding. The inter predicted feature is obtained from encoded motion feature and reference frame, whereas the intra feature is a feature based only on the current frame. In case of lossless coding of the reference frame, and in the absence of complex motion between frames, the inter predicted feature can provide a very good estimate of the information in the current frame.

On the other hand, in case of lossy coding of the reference frame, and in case of complex motion between frames, the inter predicted feature will provide a relatively poor estimate of the information in the current frame, as compared to the intra feature.

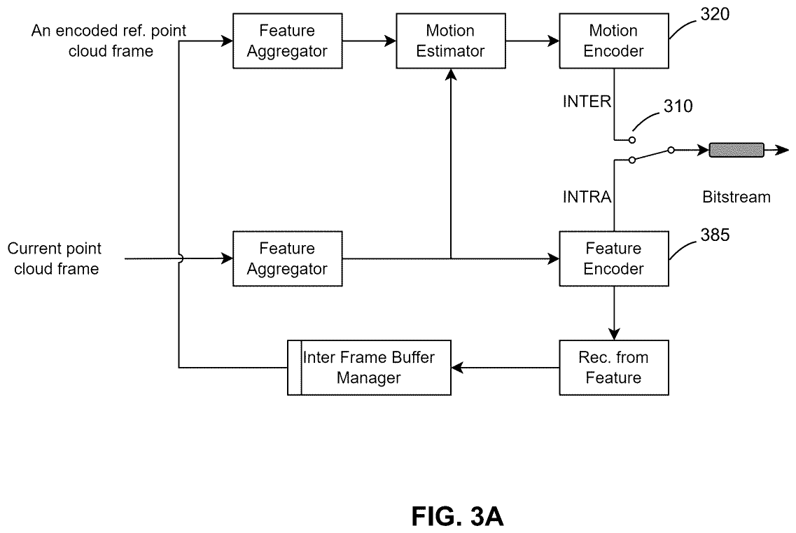

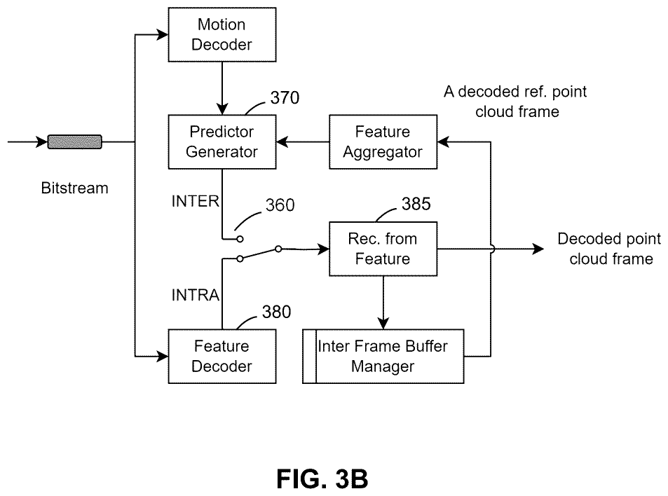

Another motivation for a simplified design using either intra or inter feature at a time but not both is the reduction in parameter and computational complexities. Without the need to merge two features, the input dimension of the Feature Encoder and Feature Decoder can be smaller which leads to fewer parameters and less computational complexity. Specifically, for the Feature Encoder as illustrated in FIG. 2F, instead of concatenation two input features, there is only one feature which is directly input to the CNN resulting in smaller input dimensions of the CNN. Moreover, there are runtime and bitrate savings since only one feature will need to be coded instead of two features. These observations lead us to design a simplified conditional coding architecture where only one feature from intra or inter is used instead of both, as shown in FIG. 3A and FIG. 3B.

Compared to FIG. 2A, one can clearly see in FIG. 3A that instead of encoding two features, the proposed architecture only encodes one feature. The feature to be coded is selected by the “Intra/Inter” module (310) according to some specified condition. In particular, when INTER is selected, the motion feature (inter feature) is encoded with Motion Encoder; when INTRA is selected, the intra feature is encoded with Feature Encoder (385). Because the Feature Encoder (385) now no longer requires the inter feature, Predictor Generator (230) in FIG. 2A is no longer required.

In one embodiment, the condition to encode inter feature is chosen when the reference frame is losslessly coded, otherwise intra feature is coded.

In another embodiment, the condition to encode inter feature is chosen when the reference frame is losslessly coded and the motion between the reference and current frame is small, otherwise intra feature is coded. The amount of motion can be calculated by a simple Chamfer distance between the two frames followed by a comparison against a user-defined threshold to check if the motion is small or large. This condition is also signaled in the bitstream.

In another embodiment, the condition to encode inter feature is chosen when the motion between frames is small, otherwise intra feature is coded.

For the decoder side, compared to FIG. 2B, one can see in FIG. 3B that instead of decoding two features, the proposed architecture only decodes one feature from the bitstream. The mode of the decoded feature is selected by the “Intra/Inter” module (360) according to signaling or some specified condition matching with the encoder side. In case the Inter condition is selected, the decoder uses the predicted feature from the Predictor Generator (370) as input to the Reconstruction from Feature module (385), whereas for Intra condition the output of Feature Decoder (380) is used as input.

### Simplified Level-by-Level Conditional Coding

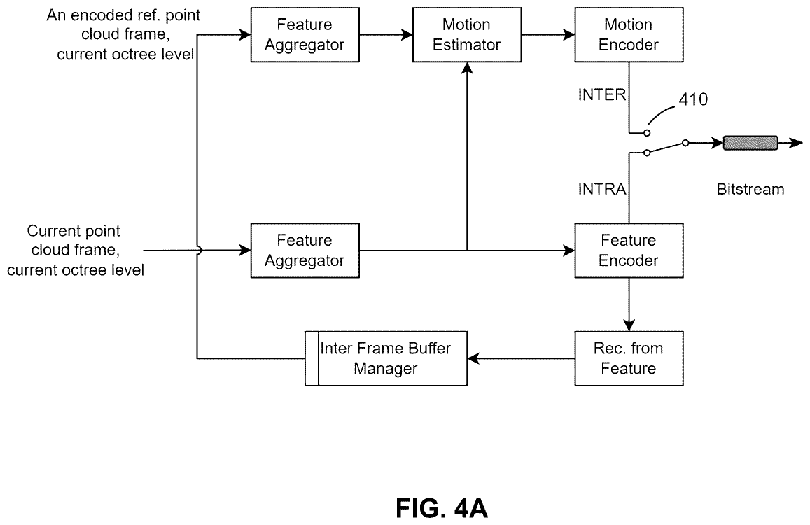

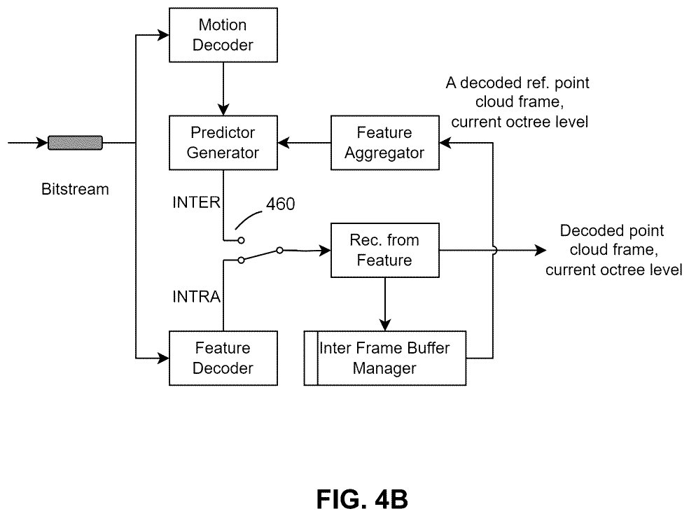

So far, the Feature-based coding has been used to encode/decode either an entire point cloud frame or several octree levels of a point cloud frame. One could also use hierarchical Feature-based coding to code a point cloud frame level-by-level. Such architecture is shown in FIG. 4A and FIG. 4B, where each bitstream represents information at a current point cloud level. Moreover, the condition to encode inter feature now depends on “Inter_level” (410), which is a user-specified parameter to denote how many levels will encode inter features starting from the root level of the octree.

In one embodiment, Inter_level is selected so that inter feature is coded only for lossless levels of the reference frame (the losslessly coded levels in the reference frame are used as reference), otherwise intra feature is coded.

In another embodiment, Inter_level is selected so that inter feature is coded only for levels with small motion between the current and reference frames, otherwise intra feature is coded.

For the decoder side, compared to FIG. 3B, the overall architecture remains the same in FIG. 4B, except that now the point cloud frame is coded level by level. That is, the condition (460) for choosing between Intra and Inter features is also applied level by level.

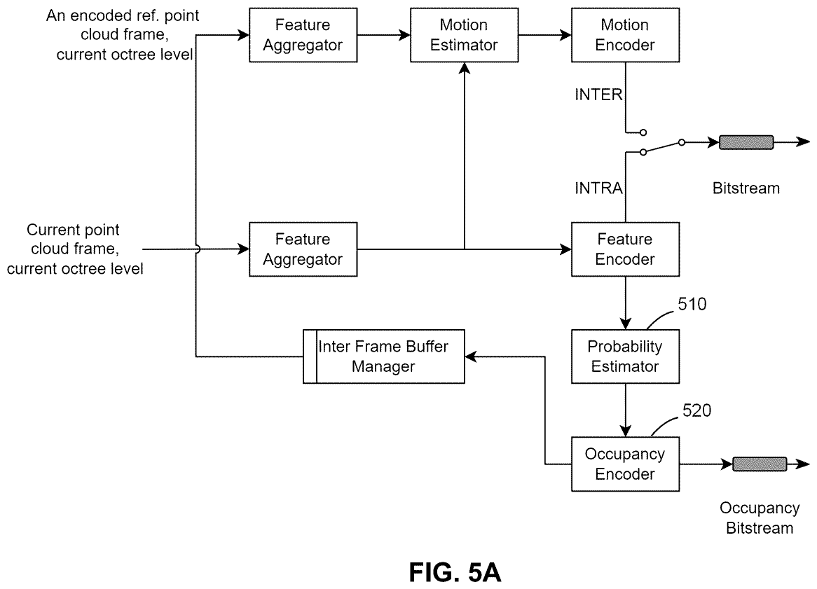

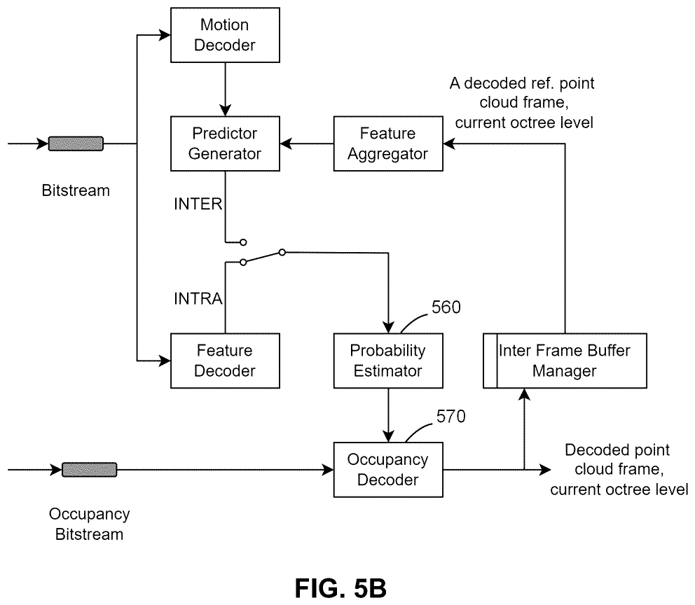

FIG. 5A and FIG. 5B also illustrate level-by-level lossless coding scenario via Octree-based Coding, according to an embodiment. In this case, the coded feature (whether inter or intra feature) is used to predict occupancy probabilities (510, 560) for the voxels at a current level. These probabilities are then used for encoding (520) and decoding (570) the actual voxel occupancies.

### Level Dependency

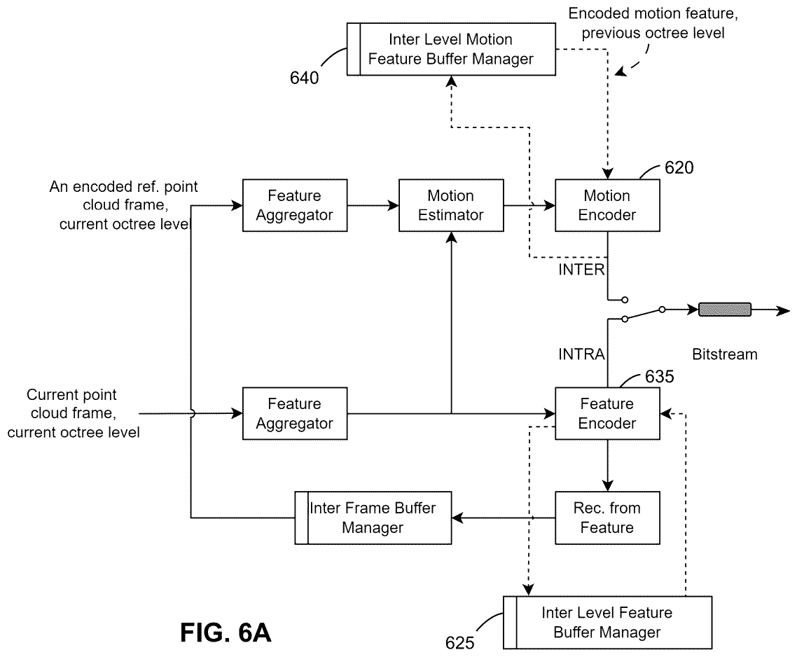

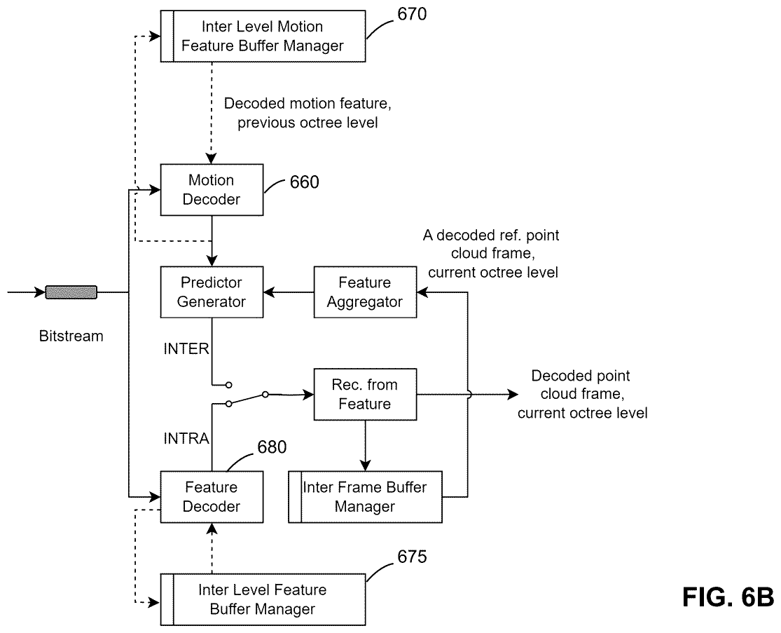

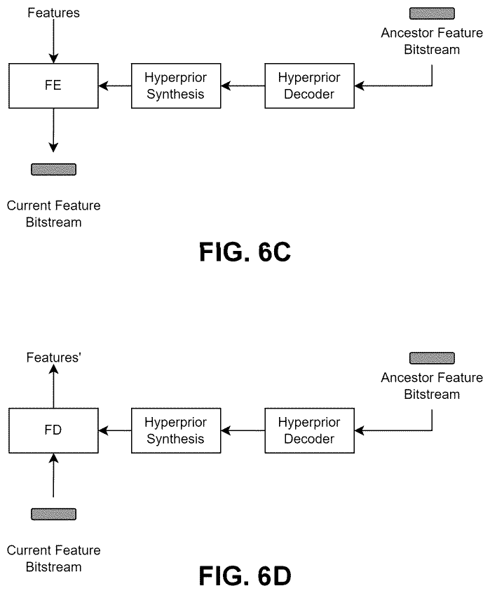

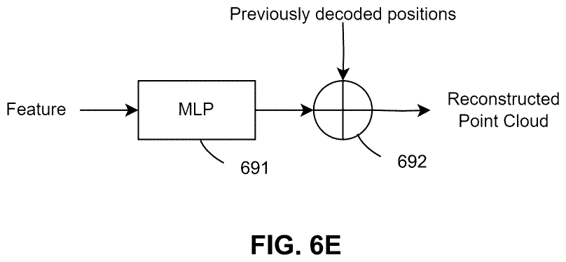

FIG. 6A and FIG. 6B illustrate another example of simplified coding where the coding at current level is also dependent on the feature encoded at ancestral level. In this case, the Feature Encoder (635) and Feature Decoder (680) as well as Motion Encoder (620) and Motion Decoder (660) use a Hierarchical Hyperprior design, as illustrated in FIG. 6C and FIG. 6D. Here, the feature encoded at ancestral level is used to predict the parameters for encoding and decoding via Hyperprior Decoder and Hyperprior Synthesis modules, instead of sending a separately encoded feature for the hyperprior (as in FIG. 2H).

For using the ancestral level feature, additional buffers (625, 640, 670, 675) are introduced which simply store the current decoded features so that they can be accessed by the Hierarchical Hyperprior at the next level. In case the previous feature was of different type than current feature, a default dummy feature of all 1's is used in place of the ancestral feature.

In one embodiment, the Reconstruction from Feature module, as illustrated in FIG. 6E, uses an offset prediction method instead of a classification method. In this case, an MLP module (691) converts the input features into a predefined number of offsets which are added (692) on top of the decoded positions from a parent level to produce a final reconstructed point cloud.

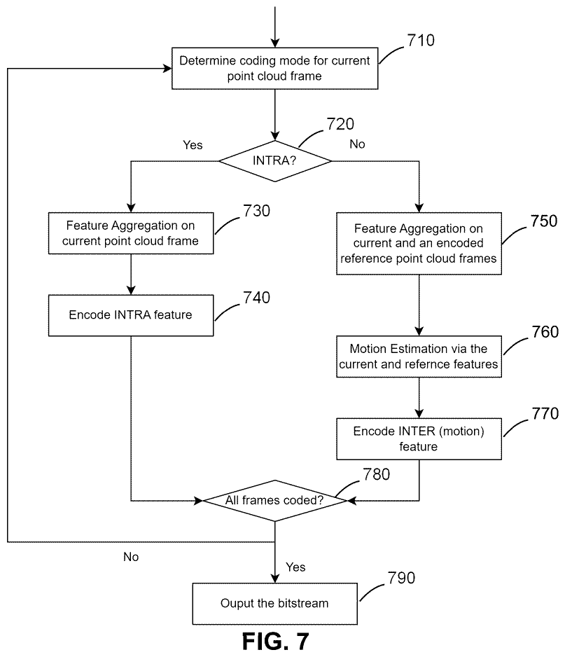

FIG. 7 illustrates a method of encoding a point cloud, according to an embodiment. As illustrated in FIG. 3A, the encoder determines (710) whether to encode the current point cloud frame in the INTRA or INTER mode. If the INTRA mode (720) is selected, the encoder performs (730) feature aggregation on the current point cloud frame to obtain the INTRA feature, which is encoded at step 740. If the INTER mode is selected, the encoder performs feature aggregation (750) on both the current point cloud frame and the encoded reference point cloud frame to obtain the current feature and the reference feature. Motion estimation (760) is performed on the current and reference features to obtain the INTER (motion) feature. The encoder encodes (770) the INTER (motion feature). At step 780, the encoder checks whether all frames are encoded. If not, the control returns to step 710. Otherwise, the encoder outputs (790) the bitstream.

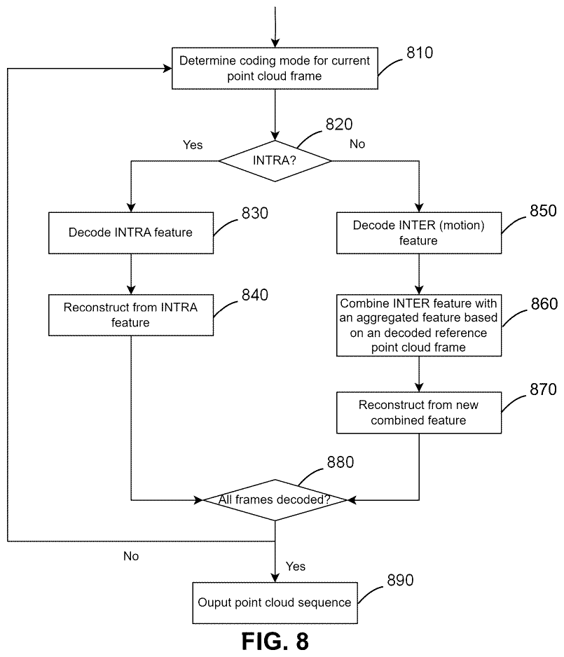

FIG. 8 illustrates a method of decoding a point cloud, according to an embodiment. As illustrated in FIG. 3B, the decoder determines (810) whether to decode the current point cloud frame in the INTRA or INTER mode. If the INTRA mode (820) is selected, the decoder decodes (830) the INTRA feature for the current point cloud frame, which is used for reconstruction at step 840. If the INTER mode is selected, the decoder decodes (850) the INTER feature, followed by feature aggregation on the decoded reference point cloud frame and combination with decoded INTER feature (860) to obtain a new feature, which is further used for reconstruction at step 870. At step 880, the decoder checks whether all frames are decoded. If not, the control returns to step 810. Otherwise, the decoder outputs the point clouds.

For another embodiment, as illustrated in FIG. 4A and FIG. 4B, the encoder and decoder can follow the same steps as in FIG. 7 and FIG. 8, respectively. However, the steps operate on a level-by-level basis instead of operating on the frame (which is akin to only operating at the last leaf level without any dependency on previous levels). This means that the inputs, outputs, and the features are all associated with a current level of the octree, and once a level is encoded/decoded, the process moves on to the next level until all levels are coded. The same level-by-level process is repeated for all frames.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding point cloud data according to the methods described above.

One or more embodiments provide a computer readable storage medium having stored thereon point cloud data generated according to the methods described above. One or more embodiments also provide a method and apparatus for transmitting or receiving point cloud data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method of decoding point cloud data, comprising:
determining a feature type to be INTRA or INTER;
decoding one of an INTRA feature and an INTER feature based on the feature type; and
decoding a point cloud frame based on one of the INTRA feature and the INTER feature.

2. The method of claim 1, further comprising:
responsive to the feature type being INTER, performing feature aggregation on the decoded feature to obtain another feature, wherein the point cloud frame is decoded based on the another feature.

3. The method of claim 2, wherein the feature aggregation comprises:
obtaining a reference feature representing one or more reference point cloud frames; and
obtaining the another feature based on the decoded feature and the reference feature.

4. The method of claim 2, wherein the decoding of the point cloud frame comprises:
performing probability estimation with the another feature; and
entropy decoding the point cloud frame with the estimated probabilities.

5. The method of claim 2, wherein the decoding of the point cloud frame further comprises:
performing probability estimation with the another feature; and
reconstructing the point cloud frame based on the estimated probability.

6. The method of claim 1, wherein the point cloud frame represents a level in a tree-based representation of a point cloud, and wherein the decoding a feature type, the decoding one of an INTRA feature and an INTER feature, and the decoding a point cloud frame are repeated for a plurality of levels.

7. The method of claim 6, wherein the decoding of a current point cloud level comprises:
obtaining decoded point locations from a previously decoded level; and
predicting one or more offsets relative to each decoded point location based on the another feature.

8. The method of claim 1, where decoding the feature type to be INTRA or INTER comprises:
decoding a parameter that indicates a number of levels starting from a root node that are to be coded in the INTER feature type; and
using the decoded parameter at each level to decide between the INTER or INTRA feature type.

9. A method of encoding point cloud data, comprising:
determining a feature type to be INTRA or INTER;
obtaining one of an INTRA feature and an INTER feature to be encoded based on the feature type; and
encoding one of the INTRA feature and the INTER feature based on the feature type.

10. The method of claim 9, wherein obtaining the INTRA feature comprises:
obtaining a feature only based on the point cloud frame.

11. The method of claim 9, wherein obtaining the INTER feature comprises:
obtaining a current feature representing the point cloud frame;
obtaining a reference feature representing one or more reference point cloud frames; and
obtaining a motion feature based on the current feature and the reference feature.

12. The method of claim 9, further comprising:
performing probability estimation with the INTRA or INTER feature; and
entropy encoding the point cloud frame using the estimated probabilities.

13. The method of claim 9, where the point cloud frame represents a level in a tree-based representation of a point cloud, and the determining, the obtaining, and the encoding are repeated for one or more levels.

14. The method of claim 9, wherein the determining the feature type to be INTRA or INTER comprises:
obtaining a parameter that indicates a number of levels starting from a root node that are to be coded in the INTER feature type.

15. An apparatus for decoding point cloud data, comprising one or more processors and at least one memory coupled to the one or more processors, wherein the one or more processors are configured to:
determine a feature type to be INTRA or INTER;
decode one of an INTRA feature and an INTER feature based on the feature type; and
decode a point cloud frame based on one of the INTRA feature and the INTER feature.

16. The apparatus of claim 15, wherein the one or more processors are further configured to:
responsive to the feature type being INTER, perform feature aggregation on the decoded feature to obtain another feature, wherein the point cloud frame is decoded based on the another feature.

17. The apparatus of claim 16, wherein the one or more processors are configured to perform the feature aggregation by performing:
obtaining a reference feature representing one or more reference point cloud frames; and
obtaining the another feature based on the decoded feature and the reference feature.

18. An apparatus for encoding point cloud data, comprising one or more processors and at least one memory coupled to the one or more processors, wherein the one or more processors are configured to:
determine a feature type to be INTRA or INTER;
obtain one of an INTRA feature and an INTER feature to be encoded based on the feature type; and
encode one of the INTRA feature and the INTER feature based on the feature type.

19. The apparatus of claim 18, wherein the one or more processors are configured to obtain the INTRA feature only based on the point cloud frame.

20. The apparatus of claim 18, wherein the one or more processors are configured to obtaining the INTER feature by performing:
obtaining a current feature representing the point cloud frame;
obtaining a reference feature representing one or more reference point cloud frames; and
obtaining a motion feature based on the current feature and the reference feature.
